(19) United States
(12) Patent Application Publication
(10) Pub. No.: US 2008/0282939 A1
(43) Pub. Date: Nov. 20, 2008

(54) Hydraulic Binder and a Chromate Reducer and Use Thereof

(76) Inventor: Alexander Kehrmann, Xanten (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 10/596,333

(22) PCT Filed: Dec. 10, 2004
(86) PCT No.: PCT/EP2004/014092

§ 371 Date: Jun. 9, 2006

(30) Foreign Application Priority Data
Dec. 12, 2003 (EP) 03028471.5

(51) Int. Cl. C04B 7/00; C09D 1/08; C04B 16/02; C04B 24/02; C04B 22/14

(52) U.S. Cl. 106/805; 106/815; 524/4; 106/802; 106/806; 106/819

(57) ABSTRACT

The invention relates to a hydraulic binder whose main constituent is cement to which a mixture comprised of a chromate reducer and a carrier material is added for chromate reduction. The chromate reducer contains two iron(II) sulfate components, with the first component is made of filter salt from the titanium dioxide production, to which a mineral acid regulator, particularly ground limestone, is added. The second component is moist copperas. The hydraulic binder according to the invention is cost-effective and has chromate contents that are considerably lower than the legally permitted limit. The invention also relates to the use of a mixture of filter salt and copperas as a chromate reducer for reducing water-soluble chromate contents in cement.

### BACKGROUND OF THE INVENTION

The invention relates to a hydraulic binder with the main constituent cement to which iron(II) sulfate is added for chromate reduction, as well as to a chromate reducer and its use.

Cement is used in the construction industry as finely ground hydraulic binder for making concrete, mortar, concrete stones and finished parts. Handling of cement involves the drawback that allergic reactions, such as skin eczema, can be triggered as a result of its chromate content. In particular the soluble chromate is hereby the cause for the allergic reactions.

It is known to use iron(II) sulfate as chromate reducer of chromate(VI) which is present in traces in cement. Iron(II) sulfate reduces the soluble chromium(VI) insoluble chromium(III). As a result, health hazards can be eliminated. The use of iron(II) sulfate as additive in cement for chromate reduction is described for example in DE 197 44 035 A1 or EP 1 314 706 A2. Also Manns, W.; Laskowski, Ch. refers in an article, entitled “Eisen(II)sulfat als Zusatz zur Chromatreduzierung” [Iron(II) sulfate as additive for chromate reduction] in BE-Z: Beton [Concrete], journal 2/1999, pages 78-85 to the same problem.

Basically it is to be noted that the reactive capability of iron(II) sulfate in cement decreases with increasing storage time and aging. The typical storage capability of cement that contains little chromate ranges from three to maximal six months. When the expiration time is exceeded, cement should no longer be used because the chromate content in cement ranges then above the legally admissible limit of 2 ppm.

It should also be noted that the use of iron(II) sulfate, in particular when preparation is cumbersome, prior to addition to cement, adversely affects costs for the hydraulic binder.

### SUMMARY OF THE INVENTION

Starting from this state of the art, the invention is based on the object to provide a hydraulic binder which is low on chromate and at least equally applicable while being lower in costs and having high storage and aging stability, and to provide a chromate reducer and use of this chromate reducer which has better practical use.

According to one aspect of the invention, a hydraulic binder includes cement as main constituent, to which a mixture of a chromate reducer and a carrier material is added, wherein the chromate reducer contains two iron(II) sulfate components, with the first component made of filter salt from the titanium dioxide production, and with the second component being copperas, and a mineral acid regulator which is added to the chromate reducer.

In accordance with the invention, a chromate reducer is used containing two iron(II) sulfate components. The first component is made of filter salt resulting from the production of titanium dioxide. The second component is copperas. In addition, a mineral acid regulator is added to both iron(II) sulfate components.

Moist copperas (iron(II) sulfate heptahydrate) is a waste or side product of various industrial processes, for example the titanium dioxide production from titanium ore. During production of titanium dioxide, using the sulfate process, finely ground titanium ore is solubilized with concentrated sulfuric acid. Iron oxide contained in the ore reacts to iron sulfate and titanium ore reacts to titanium sulfate. Separation of the iron sulfate from the titanium sulfate is realized through crystallization. Due to the higher water solubility, iron sulfate crystallizes into green iron(II) sulfate and can be extracted. This so-called copperas (iron(II)sulfate heptahydrate) is thus a waste product of the titanium dioxide production. Its consistence is moist but it still retains the same chemical properties, in particular as far as chromate(VI) reduction is concerned, as dry, ground and prepared iron(II) sulfate. Copperas is hereby significantly more cost-efficient. The same applies to filter salt produced during titanium dioxide production and involving iron(II) sulfate monohydrate. As the latter has a very high content of sulfuric acid, the acid content in filter salt is reduced in accordance with the invention by using a mineral acid regulator which is preferably mixed with the filter salt. The acid regulator assumes the added function to improve rheological properties, i.e. flow capability of the hydraulic binder.

According to another feature of the invention, a chromate reducer is used containing two iron(II) sulfate components. The first component is made of filter salt from the titanium dioxide production to which a mineral acid regulator is added. The second component is copperas.

A preferred example of a mineral acid regulator includes ground limestone. It is added to the filter salt at an amount between 3 weight-% and 18 weight-%, in particular between 5 weight-% and 15 weight-%. The ground limestone should hereby have a particle size of 0 mm to 2 mm.

According to another feature of the invention, the first iron(II) sulfate component and the second iron(II) sulfate component are mixed at a ratio of 1:1 to 1:5. In addition, an inert carrier material is added.

A free-flowing product is produced as a result of mixing the first iron(II) sulfate component and the second iron(II) sulfate component and the carrier material. The carrier material assumes within the mixture the drying function and the function of a moisture buffer or regulator. Drying and buffer effects of the carrier material ensure optimal adjustment of the mixture. Oxidation with atmospheric oxygen is avoided as is also agglomeration. There is no need to execute a cumbersome preparation or drying of copperas/filter salt before the latter is processed. Moisture regulation is assumed by the carrier material.

The presence of harmful chromate in the hydraulic binder according to the invention is effectively reduced. The binder has high storage and aging stability. In addition, it is cost-saving since iron(II) sulfate components can be used from industrial waste products.

According to another feature of the invention, a hydrophobic substance in the form of polymeric alcohols can be added to the mixture of chromate reducer and carrier material. This measure contributes to an increase of storage stability of the hydraulic binder.

The polymeric alcohols are added to the mixture of chromate reducer, comprised of the two iron(II) sulfate components and carrier material. The addition of polymeric alcohol causes iron(II) sulfate in particular to have a slight affinity to moisture or water and is less soluble or less wettable in the mixture. Iron(II) sulfate is quasi enveloped by the polymeric alcohols, thereby retaining their acidic character for a longer period. In particular, the reaction with the alkaline cement, which would result in a neutralization of the acid effect, is reduced. Iron(II) sulfate thus retains its reduction properties with respect to chromium for a longer time.

Advantageously, the polymeric alcohols are made on the basis of plastic or cellulose, especially in granular or liquid form. A hydrophobic substance that has been shown especially effective in practice is a siloxane. In particular a low-viscose poly(methylhydrogen) siloxane with trimethylsilyl end groups is well suited.

The use of siloxanes for hydrophobizing of the mixture has the advantage of the quick formation of the silicone resin network, the absence of volatility, and the smaller alcohol release during reduction so that good effectiveness is provided even in a heavily aspirating environment.

The content of the hydrophobic substance, i.e. the polymeric alcohols in the mixture of chromate reducer and inert carrier material, ranges suitably between 0.5 weight-% to 10 weight-%, preferably between 1 weight-% and 5 weight-%, in relation to the mixture quantity.

Examples of inert carrier materials include fine-grained or powdery substrates having large surface structure and exhibiting hydroscopic properties, i.e. ability to absorb or release moisture. By adding a hydrophobic substance to the mixture, the hydrophobic properties of the polymeric alcohols and of the hydroscopic properties of the carrier material are combined.

An example of an especially effective carrier material involves silica gel. Silica gel involves a solid amorphous silicic acid, the use of which as adsorbent for gases, vapors, and liquids, is generally known. It can be made with different pore openings. Silica gel absorbs moisture on its large inner surface which may range up to 800 m²/g.

Also alumina, in particular activated alumina, can be used as carrier material. Activated alumina is activated aluminum oxide (Al₂O₃) and involves a natural clay mineral (bentonite) in crumbly form with similar adsorption properties for moisture as silica gel.

Practical tests have shown that dry sand at a particle size between 0.1 mm and 0.4 mm affords very good properties as carrier material in the mixture.

A further feature of the invention involves another alternative carrier material, involving catalyst powder which has also effective properties as carrier material and involves in particular catalyst powders from Claus processes, i.e. desulphurization processes, especially those in crude oil and natural gas refineries. Those are used as carrier material within the mixture. In this way, a further industrial waste product can be supplied for meaningful further processing. Catalyst powder from Claus processes are characterized by a large inner surface and good moisture adsorption capability.

The content of carrier material in relation to the amount of chromate reducer ranges between 5 weight-% and 15 weight-%, in particular at about 10 weight-%. At these contents, the function of the carrier material as moisture buffer or regulator can be reliably realized.

According to another feature of the invention, the mixture of chromate reducer and carrier material is added to the hydraulic binder at an amount between 0.01 weight-% to 5.0 weight-%, in particular between 0.2 weight-% to 1 weight-% in relation to the cement quantity. This results in an effective reduction of the chromate content to below limit values that are considered health hazards.

The chromate reducer according to the invention for reduction of water-soluble chromate contents in cement includes a mixture of filter salt from the titanium dioxide production (iron(II) sulfate monohydrate) as well as copperas (iron(II) sulfate heptahydrate) and a mineral acid regulator. The components of the chromate reducer can be mixed basically in any random sequence.

As already stated above, it is within the scope of the invention to use ground limestone as mineral acid regulator. The mineral acid regulator is added to the chromate reducer at an amount between 3 weight-% and 18 weight-%, preferably 5 weight-% to 15 weight-% in relation to the amount of filter salt (iron(II)sulfate monohydrate). Practical tests have shown good results, when using a chromate reducer in which filter salt and copperas are mixed at a ratio of 1:1 to 1:5 while mineral acid regulator is added.

### BRIEF DESCRIPTION OF THE DRAWING

### None

### DETAILED DESCRIPTION OF PREFERRED EMBODIMENTS

None

1. A hydraulic binder, comprising:
cement as main constituent;
a mixture of a chromate reducer and a carrier material is added to the cement, wherein the chromate reducer contains two iron(II) sulfate components, with a first component made of filter salt obtained during titanium dioxide production, and with a second component being green salt; and
a mineral acid regulator added to the chromate reducer.

2. The hydraulic binder to of claim 1, wherein the mineral acid regulator is added to the filter salt.

3. The hydraulic binder to of claim 1, wherein the mineral acid regulator is ground limestone.

4. The hydraulic binder of claim 1, wherein the mineral acid regulator is added at an amount between 3.0 weight-% and 18 weight-% in relation to the amount of filter salt.

5. The hydraulic binder of claim 1, wherein the first component and the second component are mixed at a ratio of 1:1 to 1:5.

6. The hydraulic binder to claim 1, further comprising a hydrophobic substance in the form of polymeric alcohols for addition to the mixture.

7. The hydraulic binder of claim 6, wherein the polymeric alcohols are made on the basis of plastic or cellulose, in granular or liquid form.

8. The hydraulic binder of claim 1, further comprising a hydrophobic substance in the form of a siloxane for addition to the mixture.

9. The hydraulic binder of claim 1, wherein the carrier material is a silica gel.

10. The hydraulic binder of claim 1, wherein the carrier material is activated alumina.

11. The hydraulic binder of claim 1, wherein the carrier material is dry sand at a particle size between 0.1 mm and 0.4 mm.

12. The hydraulic binder of claim 1, wherein the carrier material is a catalyst powder.

13. The hydraulic binder of claim 1, wherein carrier material in the mixture is at an amount between 5 weight-% and 15 weight-% in relation to the amount of chromate reducer.

14. The hydraulic binder of claim 1, wherein the mixture is present at an amount between 0.01 weight-% to 5.0 weight-% in relation to a content of cement.

15. A chromate reducer, comprising a mixture of two iron(II) sulfate components and an acid regulator, with a first iron(II) sulfate component being filter salt obtained during titanium dioxide production, and a second iron(II) sulfate component being green salt.

16. The chromate reducer of claim 15, wherein the acid regulator is a mineral acid regulator.

17. The chromate reducer of claim 15, wherein the acid regulator is present at an amount between 3 weight-% and 18 weight-%, in relation to the amount of filter salt.

18. The chromate reducer of claim 15, the first component and the second components are mixed at a ratio of 1:1 to 1:5.

19. A method of reducing the content of water-soluble chromate in cement, comprising the steps of:
preparing a mixture of iron(II) sulfate in the form of filter salt obtained during titanium dioxide production and iron(II) sulfate in the form of green salt and a mineral acid regulator to produce a chromate reducer for; and
adding the mixture to cement.

20. The hydraulic binder of claim 1, wherein the mineral acid regulator is added at an amount between 5 weight-% and 15 weight-% in relation to the amount of filter salt.

21. The hydraulic binder of claim 3, wherein the limestone has a particle size of 0 mm to 2 mm.

22. The hydraulic binder of claim 8, wherein a content of the hydrophobic substance in the mixture ranges between 0.5 weight-% to 10 weight-%.

23. The hydraulic binder of claim 8, wherein a content of the hydrophobic substance in the mixture ranges between 1 weight-% and 5 weight-%.

24. The hydraulic binder of claim 1, wherein the mixture is present at an amount between 0.2 weight-% and 1 weight-% in relation to a content of cement.

25. The chromate reducer of claim 15, wherein the acid regulator is ground limestone.
